(19) United States
(12) Patent Application Publication
(10) Pub. No.: US 2010/0189316 A1
(43) Pub. Date: Jul. 29, 2010

(54) SYSTEMS AND METHODS FOR GRAPH-BASED PATTERN RECOGNITION TECHNOLOGY APPLIED TO THE AUTOMATED IDENTIFICATION OF FINGERPRINTS

(75) Inventor: Mark A. Walch, Fairfax Station, VA (US)

Correspondence Address: PROCOPIO, CORY, HARGREAVES & SAVITCH LLP, 525 B STREET, SUITE 2200, SAN DIEGO, CA, 92101, US

(73) Assignee: GANNON TECHNOLOGIES GROUP, LLC, McLean, VA (US)

(21) Appl. No.: 12/611,893

(22) Filed: Nov. 3, 2009

Related U.S. Application Data
(60) Provisional application No. 61/147,720, filed on Jan. 27, 2009.

(51) Int. Cl. G06K 9/68; G06T 7/00; G06K 9/46

(52) U.S. Cl. 382/125; 382/218; 382/187

(57) ABSTRACT

A method for fingerprint recognition comprises converting fingerprint specimens into electronic images; converting the electronic images into mathematical graphs that include a vertex and an edge; detecting similarities between a plurality of graphs; aligning vertices and edges of similar graphs; and comparing similar graphs.

### RELATED APPLICATIONS INFORMATION

This application claims priority under 35 U.S.C. 119(e) to U.S. Provisional Patent Application Ser. No. 61/147,720, entitled “Graph-Based Pattern Recognition Technology Applied to the Automated Identification of Fingerprints,” filed Jan. 27, 2009 and which is incorporated herein by reference in its entirety as if set forth in full.

This application is also related to U.S. patent application Ser. No. 10/791,375, entitled “Systems and Methods for Source Language Word Pattern Matching,” filed Mar. 1, 2004 and which is also incorporated herein by reference in its entirety as if set forth in full. This application is also related to U.S. patent application Ser. No. 10/936,451, now U.S. Pat. No. 7,362,901, entitled “Systems and Methods for Biometric Identification Using Handwriting Recognition,” filed Sep. 7, 2004 and which is also incorporated herein by reference in its entirety as if set forth in full

### BACKGROUND

1. Technical Field

The embodiments described herein related to using graph-based pattern recognition technologies to analyze fingerprints so as to match two or more identical prints, and more specifically to the used of graph-based pattern matching to achieve matches using latent prints, and/or partial prints.

2. Related Art

Fingerprinting as a method of biometric identification has been around for quite sometime. For example, since 1911, when first introduced into evidence in a criminal trial, testimony that a fingerprint found at a crime scene was an exact match for individual identity has been permitted in criminal judicial proceedings without challenge. The Automated Fingerprint Identification System (“AFIS”) has become a mainstay of the criminal prosecution arsenal, with for example a reported ten times more unknown suspects in most jurisdictions being identified based upon fingerprint matching than upon DNA.

As terrorism becomes more prevalent throughout the world, the use of biometrics to identify persons of interest for various objectives, most notably to prevent terrorists from entering, e.g., the United States through a supplement to the Terrorist Watch List, has potentially added another strategic use for fingerprint matching.

At the core of any AFIS system is the ability to match a print to an exemplar. Matching latent prints with corresponding exemplars requires highly skilled human expertise. As to potential use in the war on terrorism, the issue is a capacity to achieve automated processing to the level required for identification (Level 3, being qualitative friction ridge analysis) within the requisite response times. As to criminal prosecution, challenges are being made concerning the ability of fingerprint identification to meet standards established for the admissibility of such testimony into criminal judicial proceedings by the Supreme Court (the “Daubert” challenge).

Current fingerprint analysis techniques are vulnerable to the Daubert challenge in the courts. The Daubert case set forth five factors that trial courts may consider in making a determination of “scientific validity”. These first three factors are:
1. Whether the theory or technique can be and has been tested, noting that the statements constituting a scientific explanation must be capable of empirical testing;
2. The known or potential rate of error of the particular technique; and
3. The existence and maintenance of standards controlling the technique's operation.

Conventional methods for fingerprint identification lack a solid mathematical foundation on which to establish the scientific basis of fingerprint identification, e.g., confirm the basic premise that a fingerprint is a unique identifier, with the techniques being used to establish such identity accurate to the requisite levels.

In conventional methods, identification is made on the basis of the ridge characteristics of the fingerprint. Yet, there appears to be no standard agreement among examiners as to which ridge characteristics are most indicative of identity. Additionally, there is no current agreement among examiners as to the number of points of ridge characteristics in common that are necessary to establish identification. Some argue that there should be no minimum standard, with the decision left to the subjective judgment of the examiner. It appears to be documented, however, that fingerprints from different people can share a limited number of ridge characteristics in common. Israeli fingerprint examiners, for example, have found fingerprints from two different people that contain seven matching ridge characteristics.

No scientific study has been performed that reasonably indicates the probabilities of fingerprints from different people having varying numbers of matching ridge characteristics. Accordingly, latent print examiners do not offer opinions of identification in terms of probability, resorting instead to a statement of “absolute certainty” for their identifications.

All prints, both inked and latent, are subject to various types of distortions and artifacts: The most common is pressure distortion. Even though such distortions can cause a ridge characteristic to appear as something other than that, no study has been conducted to determine the frequency with which such distortions occur, and the extent to which such distortions can adversely impact identification.

### SUMMARY

Systems and methods for graph based fingerprint detection are disclosed herein.

According to one aspect, a method for fingerprint recognition comprises converting fingerprint specimens into electronic images; converting the electronic images into mathematical graphs that include a vertex and an edge; detecting similarities between a plurality of graphs; aligning vertices and edges of similar graphs; and comparing similar graphs.

According to another aspect, a fingerprint recognition system for searching fingerprints in a source language comprises an imaged fingerprint, the imaged fingerprint being stored in a fingerprint database; a fingerprint library for storing fingerprint templates; an image graph constructor coupled to the fingerprint database and the template library, the image graph constructor configured to generate image graphs from the templates, and generate a collection of image graphs representing the imaged fingerprint by performing an image graph generation process, the process comprising the steps of: reducing fingerprint features in the templates and in the imaged fingerprint to skeleton images comprising a plurality of nodes and a plurality of connections, representing the skeleton images using a Connectivity Key that is unique for a given plurality of nodes and connections between the given plurality of nodes, and constructing the template graphs and collection of image graphs from image graphs of the imaged fingerprint; an image graph database for storing the template image graphs and the collection of image graphs generated by the image graph constructor; and a comparison module coupled to the image graph database, the comparison module configured to search the imaged documents by comparing the collection of image graphs with selected template image graphs, wherein if at least one image graph from the collection of image graphs matches the selected template image graphs, the imaged fingerprint is flagged.

These and other features, aspects, and embodiments are described below in the section entitled “Detailed Description.”

### BRIEF DESCRIPTION OF THE DRAWINGS

Features, aspects, and embodiments are described in conjunction with the attached drawings, in which:

FIG. 1 is a diagram illustrating example embedded graphs in a Chinese word;

FIG. 2 is a general diagram outlining a data capture and mining method according to one embodiment;

FIG. 3 provides a detailed illustration of image graph and image graph library creation according to one embodiment;

FIG. 4 is a diagram illustrating two example isomorphic graphs;

FIG. 5 is a diagram illustrating an example process for generating a connectivity key in accordance with one embodiment;

FIGS. 6A and B are diagrams illustrating embedded graph forms in a finger print;

FIGS. 7A and B are diagrams illustrating an original fingerprint and ridge lines extracted therefrom;

FIG. 8 is a diagram illustrating examples of ridge bifurcations and endings in a fingerprint image;

FIG. 9 is a diagram illustrating examples of varying degrees of ridge break separations in a finger print;

FIGS. 10A-C are diagrams illustrating ridge connectivity in increasingly blurred fingerprint;

FIGS. 11A and 11B are diagrams illustrating disjointed ridges connected by soft vertices;

FIG. 12 is a diagram illustrating identification of similar embedded graphs in accordance with on embodiment;

FIG. 13 is a diagram illustrating embedded sub-graphs within a fingerprint;

FIG. 14 is a diagram illustrating conditionally embedded sub-graphs in a sample Chinese word;

FIG. 15 is a diagram illustrating an example method for pictographic searching in accordance with on embodiment; and

FIG. 16 is a diagram illustrating a pictographic search system configured to implement the process illustrated in FIG. 15.

### DETAILED DESCRIPTION

The embodiments that follow relate to an approach for identifying fingerprints that does not rely on conventional minutiae-based methods. The minutiae-based methods rely on a certain quantity of point features observable within a fingerprint. The methods herein discussed use graphs to capture much more of the information presented by fingerprint physiology taking into consideration both the topology and geometry of ridges and other features.

By capturing much of the information that fingerprints offer, the systems and methods described herein permit fingerprint-based identification to take place with considerably less information than conventional methods. That is, partial latent prints that currently present too little information for conventional methods to accurately perform matching, can now be matched using the systems and methods described herein.

Accordingly, the various embodiments described herein and those that can be gleaned therefrom can allow the following:
1. Match and align latent prints with exemplar results provided by an AFIS search;
2. Locate partial latent prints within a database of print exemplars; and
3. Use graphs as a framework for evaluating Level 3 information such as pores and ridge detail.

The related U.S. Pat. No. 7,362,901 patent (“the '901 patent”) incorporated above is directed to using graph-based pattern matching in such a way as to allow handwriting to act as a biometric identifier. At a macro level, fingerprints present a pattern that is quite similar to handwriting in that graphs can be built directly from fingerprint images. At the finer level of detail, the fingerprint ridges themselves exhibit patterns, such as shape, pores and breaks, that properly processed can be captured using graphs in a format supportive of analysis currently unavailable. The methods herein described provide the means for improving conventional fingerprint identification by providing: (1) a method for extracting more biometric content from Level 1 (ridges) and Level 2 (minutiae) features, and (2) creating a platform for the introduction of Level 3 (pores and ridge features) into automated fingerprint identification.

This is accomplished using graphs to quantify physical features within fingerprints. The graphs can, e.g., either be obtained from scanned images of inked prints or captured directly from a fingerprint scanner. Regardless of the scanning method, the fingerprint is rendered into an image and once rendered into an image, it is automatically converted into graphs. Such a graph can comprise a two-part data structure. This structure can contain relational information expressed by graphs and physical characteristics represented by physical data. Some of the characteristics of this data structure include:
1. A measure of a graph's topology expressed as a numeric encoding
2. Knowledge of the graph's internal structure to enable point-to-point comparisons with graphs having the same (isomorphic) topology;
3. Representation of the complete sub-graph structure of the graph including all embedded graphs; and
4. Physical features in the form of distance, angular and other measurements of components that comprise the object being expressed as a graph.

An example of how this information works in language-based recognition of Chinese characters yields a good foundation for how it can be applied to fingerprints. Similar to the ridges of a fingerprint, e.g., Chinese words are line-based structures that can be turned into graphs. Since the full graphs of handwritten words are virtually never quite identical, the sub-graph structure can then be used to identify the Chinese word. That is, in the case of the Chinese word, the “whole” (word) can be recognized as the sum of some set of “parts”. These parts are embedded graphs.

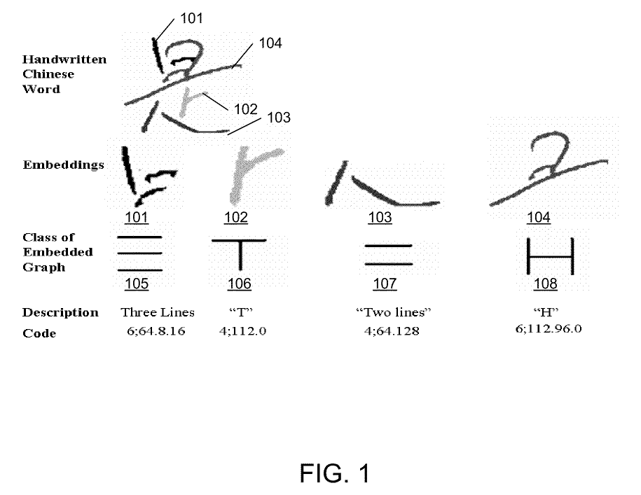

FIG. 1 illustrates the relationship between a handwritten Chinese word 100 and the most common embedded graphs 101-104. Attendant to each embedded 101-104 is a generic description of the “class” of graph 105-108 based on its topology. Using the topology encoding method herein described, each of these topologies will have a unique description, code, or both that will be consistent for all topologies that are isomorphic.

The Chinese word illustration is directly relevant to fingerprint identification with the pen “strokes” of the writing corresponding to the physical “ridges” that comprise fingerprints. A more detailed discussion of systems and methods for language based recognition are included below. It will be understood based on the below descriptions that these systems and methods can readily be modified for use in fingerprint recognition.

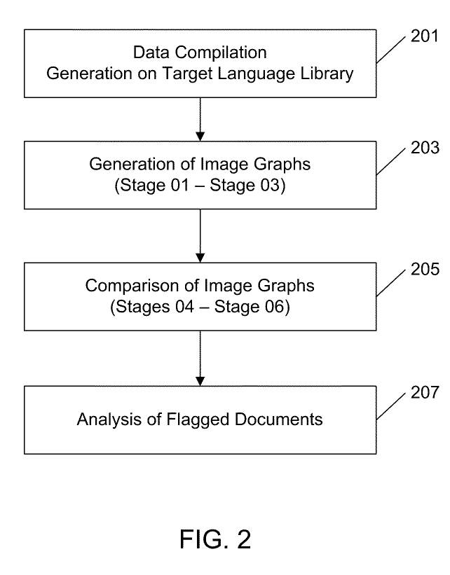

FIG. 2 of co-pending U.S. patent application Ser. No. 10/791,375 (“the '375 application”), which is recreated in the accompanying figures as FIG. 2, discloses an example method for source language pattern matching in which, e.g., words or sentences can be detected and matched using a library of know words and sentences. In the example method, a data compilation step 201 takes place in which a target language library is created. This is a library of what can be referred to as template graphs. In the embodiments described herein, this can be a library of known finger prints or partial finger prints. Next, in step 203, image graphs are obtained. In step 205, the image graphs can then be compared to the templates in the target library. In step 207, analysis of flagged documents, or in this case fingerprints can then take place.

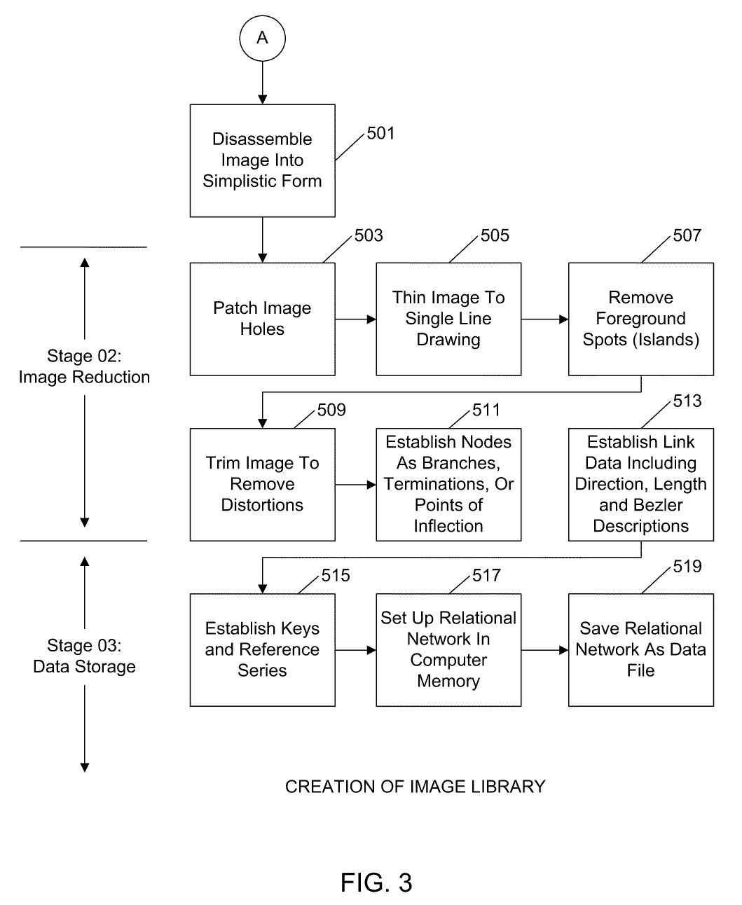

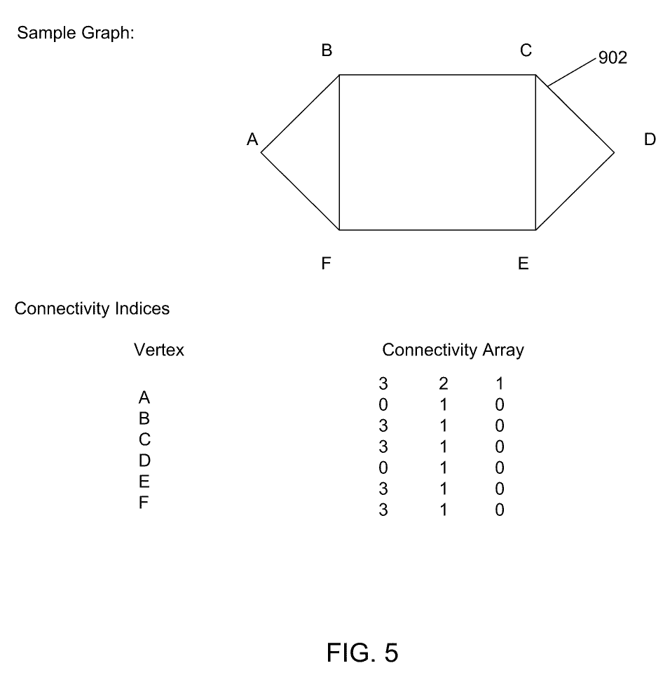

FIG. 5 of the '375 application, which is recreated here as FIG. 3, illustrates an example process for generation of image graphs in accordance with one embodiment. Referring to step 515, it can be seen that one step in the process is the generation of keys and references that can be used to search and compare graphs. In the example of the '375 application, isomorphic keys, based on an isomorphic array are used, and the same type of key can be used in the case of fingerprints. The established Connectivity Keys and Connectivity Array can be items contained in a header and used for quick screening of stored images prior to the searching process. The screening and searching processes can be directly related to the manner and format by which information is stored. Specifically, the storage formats can permit screening and retrieval of information in two ways: 1) by Connectivity Key, and 2) by Connectivity Array.

The numeric Connectivity Array is an attribute of each image created to facilitate the screening and searching processes. Unlike the Connectivity Key, which is used for matching, the Connectivity Array is used to screen image comparisons to determine if a match is even possible between images in a document and the search term image graphs. Whereas the Connectivity Key works by “inclusion”, the Connectivity Array works by “exclusion”. The Connectivity Array consists of an array of integers, each of which represents a total number of nodes with a certain number of links. Connectivity Arrays can be tabulated for individual nodes as well as entire images.

In summary, in the example of the '375 Application, the image reduction stage can result in a graph image library having skeletal representations for each character contained in the source language library. In the examples described herein, these skeletal representations can represent fingerprints, portions of fingerprints, or both.

As noted, the Connectivity Keys are used for inclusionary screening. The Connectivity Key can be generated and unique for a given number of nodes connected in a specific manner. In short, the Connectivity Key is a string of characters that distinguishes images from each other. The purpose of the key is to identify images with very similar characteristics for a more detailed analysis. The Connectivity Key captures the essence of the link/node relationships contained in the stored image data by storing this information in such a form that it can be referenced very quickly using conventional key referencing techniques.

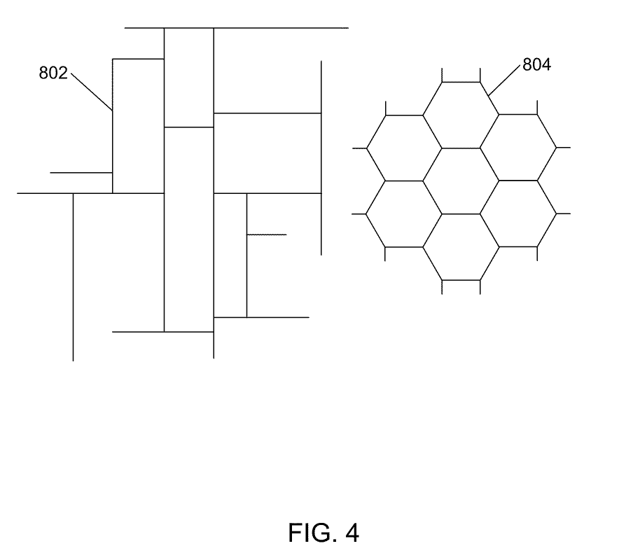

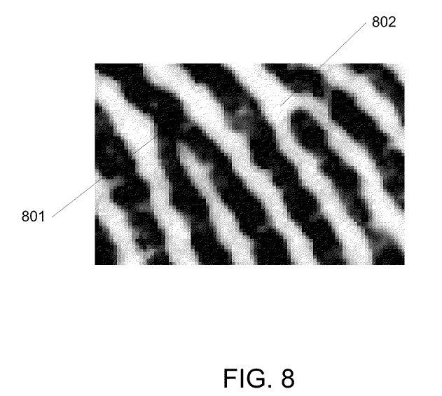

Connectivity Key generation can be viewed as a technique for generating a unique numeric value for each possible graph isomorphism. That is, two graphs sharing the same topology, e.g., having edges and vertices connected in the same way, should generate the same key, regardless how the edges and vertices are geometrically arranged. For example, FIG. 8, recreated here as FIG. 4, shows two isomorphic graph FIGS. 802 and 804. Although these figures appear to be different, their underlying graphs are structured identically, i.e., they are isomorphic.

The systems and methods described herein can be configured to use a method for detecting isomorphism by rearranging graph adjacency matrices. A graph's adjacency matrix can be defined as a two-dimensional table that shows the connections among vertices. In a typical adjacency matrix, vertices are shown along the (x) and (y) axes and the cells within the table have a value of “0” if there is not edge connecting the vertices and a value of “1” if the vertices are connected. The arrangement of “0's” and “1's” within the matrix is a function of the arrangement of vertices. Two graphs are isomorphic if their adjacency matrices align. That is, if the pattern of “O's” and “1's” is exactly the same, the two graphs must be identical. Theoretically, it is possible to consider all possible vertex arrangements to determine isomorphism. However, for a graph of Order “n”, there are “n!” possible arrangements. The potential magnitude of this value, particularly if multiple graphs are to be compared, negates any benefit of brute force solutions to this problem.

In the systems and methods described herein, isomorphism is solved by applying an organized reordering to the matrix based on vertex connectivity. Under this approach, a matrix is reordered into a final state of “equilibrium” based on balancing a vertex's “upward connectivity” with its “downward connectivity”. Upward connectivity is defined as the collective weight of all vertices of greater order to which a particular vertex is connected. Downward connectivity is described as the weight of all vertices of lesser order to which a vertex is connected. Order is defined as the number of edges emanating from a particular, vertex.

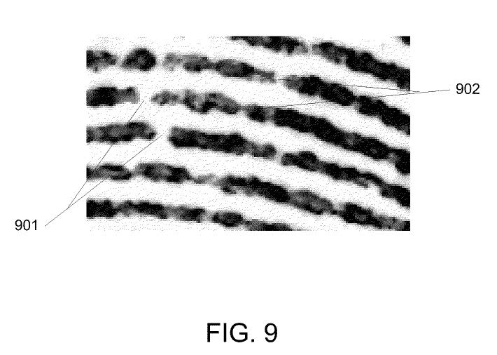

Upward and downward connectivity can be stored as an array of integers. FIG. 9, recreated here as FIG. 5 illustrates how these two types of connectivity can be established according to one embodiment. Using the concept of connectivity, it is possible to arrange the vertices into a consistent final state reflecting a balance between upward and downward connectivity. For isomorphic graphs, this state will take the form of an adjacency matrix with a certain final order for vertices, regardless of their original position in the matrix. All isomorphic graphs will transform into the same final state.

The following steps describe the process by which an adjacency matrix can be reordered using connectivity. These steps utilize some of the methods described in U.S. Pat. No. 5,276,332 (“the '332 patent”) and incorporated herein by reference as if set forth in full. Specifically, the concept of the Connectivity Array follows the methodology described for the Cumulative Reference series in the '332 patent. However, additional processes are applied for using information contained in the Connectivity Array that are not necessarily discussed in the '332 patent.

The Connectivity Array can, therefore, be built in the following manner. First, the connectivity for each vertex can be established through an array of integers. For example, the connectivity can be established by conducting a breadth first search from each vertex moving into all connected vertices and extending until a vertex of equal or greater order is encountered. This information is recorded in an array of integers where each value in the array maintains the count of vertices of a particular order encountered and the subscript reflects the actual order.

FIG. 5 herein presents a sample graph along with the Connectivity Arrays established for every vertex within the graph. Once the Connectivity Array has been established, the vertices are sorted by this array. Sorting can be performed by comparing the counts for similar order counts with the greatest weight given to the higher order counts. That is, the array elements corresponding to the “higher order” vertices, i.e., vertices with more edges, take higher precedence for sorting. For example, a “degree 4” vertices take precedence over a “degree 3” vertices, and so on.

Depending on the embodiment, once the sort is complete, connectivity can be balanced by two additional steps: 1) Pull, or Upward Connectivity, 2) Push, or Downward Connectivity. The Pull step can begin with the highest ranked vertex and working down the list of vertices, each vertex's lower ranked “neighbors”, i.e. directly connected vertices, are examined. A “neighbor” vertex can then be “pulled” up the list if the preceding node meets the following criteria: a) The preceding vertex in the list has the same Connectivity Array (CA); b) The preceding vertex has not already been “visited” during this iteration; and c) The preceding vertex has an equivalent “visited by” list to the current node.

Logic underlying this process can be outlined in the following exemplary “Pseudo Code” description, generated according the requirements of one example implementation. This logic presumes construction of a vertex list from the sorting process with the highest ranked vertex at the top of the list and the lowest at the bottom. Ranking is performed by sorting using the Connectivity Array.

For each vertex in the vertex list

```
{
1. Get all “neighbors” (vertices connected to this vertex) in the
order in which they appear in the list and prepare a separate
“neighbor vertex list”.
2. Mark this vertex as “visited”.
3. For each neighbor in the neighbor vertex list
{
3.1 Get the vertex that precedes this neighbor in the vertex list.
3.2 While the neighbor's Connectivity Array = the preceding
vertex's Connectivity Array.
    And the preceding vertex is not “visited”.
    And the neighbor's “visited by” list = the
preceding vertex's “visited by” list.
{
3.2.1 Swap the positions of the neighbor and the preceding vertex
in the vertex list.
3.2.2 Get the vertex that precedes this neighbor in the vertex list.
}
3.3 Mark this neighbor as “visited”.
3.4 Mark this neighbor as having been “visited by” this vertex.
}
4. Clear all vertices of “visited” status.
}
```

The Push, or Downward Connectivity Step can begin with the lowest ranked vertex and working up the list of vertices, adjacent pairs of vertices in the list are examined, comparing the ranks of their “upstream” and “downstream” connections, i.e., directly connected vertex that are ranked above the vertex in the list arid below the vertex in the list, respectively. A vertex can be “pushed” down the list if the following criteria are met: a) The subsequent vertex in the list has the same Connectivity Array, and one of the following is true: i) The subsequent vertex has stronger “upstream” connections, or ii) The “upstream” connections are equal and the vertex has stronger “downstream” connections. Determining “stronger” connections entails a pair-wise comparison of the sorted ranks of each vertex's connections, and the first unequal comparison establishes the stronger set.

The Push Process can be articulated in the following example Pseudo Code generated in accordance with one example implementation:

For index = N to 2
{
1. Get vertex at position index - I
2. Get the next vertex at position index
3. If the vertex's Connectivity Array = the next vertex's
Connectivity Array
{
3.1 Get the vertex's “upstream” and “downstream” connections
3.2 Get the next vertex's “upstream” and “downstream”
connections
3.3 If the next vertex's “upstream” > vertex's “upstream”
{
3.3.1 Swap the positions of the vertex and the next vertex in the
vertex list
}
Else if the “upstream” connections are equal
{
3.3.2 If the vertex's “downstream” > next vertex's “downstream”
{
3.3.2.1 Swap the positions of the node and the next vertex in the
vertex list
}
}
}
}

At the conclusion of the initial sort, the push process and the pull process, vertices are arranged in an order reflective of their balance between upward and down. At this point the adjacency matrix can be reordered to reflect this balance. Once the adjacency matrix has been reordered, the “O's” and “1's” within the matrix can become the basis for a numeric key that becomes a unique identifier for the matrix and a unique identifier for the isomorphism shown in the matrix.

The graph in FIG. 5 herein can be used to illustrate the key generation process.

FIG. 5 presents a symmetrical graph 902 that requires the benefit of both Pull and Push techniques. It should be noted that the Push step may not be necessary for graphs that are not symmetric. Within FIG. 5, a table is provided that illustrates the Connectivity Arrays for each vertex. The Connectivity Array is computed by counting the number of vertices of particular order connected to each individual vertex. Because, the highest order in the graph is 3—the most vertices emanating from a single edge is 3—the Connectivity Array includes orders up to and including 3.

Because vertices B, C; E and F have equal Connectivity Indices, they can be sorted into a number of orders with each one likely to be in the first sort position. For purposes of this illustration, it is assumed that sorting the vertices based on the Connectivity Array produced the following order:

(1) C, (2) B, (3) E, (4) F, (5) A, (6) D

Once this order has been established, the Pull step can be applied for upward connectivity. In this case, Vertex C can pull Vertex D ahead of Vertex A. This pull occurs because Vertex D is directly connected to Vertex C, which is in the first position. Vertex A is connected to Vertices B and F, neither of which is in a position higher than C. Once this rearrangement of order has been performed, there are no more changes to be made by the Pull process and the order is now shown as follows.

(1) C, (2) B, (3) E, (4) F, (5) D, (6) A

Next, the Push process is applied. The Push process moves vertices up-to the left in this example-based upon downward connectivity. In this case, Vertex E has stronger downward connectivity than Vertex B because Vertex E is connected to Vertex D, rank position 5, and Vertex B is connected to Vertex A, rank position 6. The result is Vertex D can push Vertex B ahead of Vertex E. This push reorders the series as follows.

(1) C, (2) E, (3) B, (4) F, (5) D, (6) A

Upon this change, the arrangement of vertices becomes stable and no additional pushing is possible. The result is a unique ordering that will always occur for this particular graph topology regardless the original ordering of the vertices.

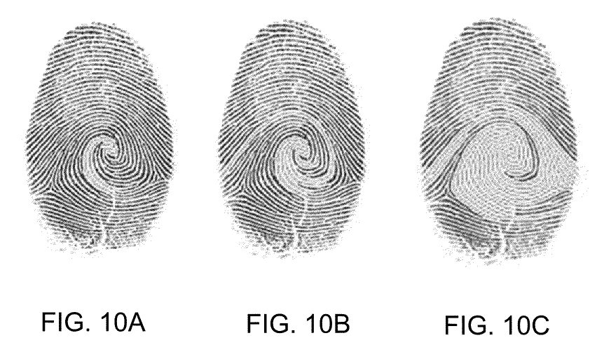

The final step in this process involves taking the resultant adjacency matrix and converting it into a key. FIG. 10 shows the “before” and “after” versions of a graph adjacency matrix for graph 902 in FIG. 5. Since the matrix is by nature in a binary format, there are numerous ways to build it into a numeric key. One method is to assign sequential ranks to each cell in the matrix and multiply the integer 2″, where n is the rank of the cell, by the value in the cell. Another method is to map the adjacency matrix into an integer with sufficient size to accommodate all the cells in the matrix. Either of these methods can, for example, yield an integer key that uniquely represents the graph's isomorphism.

Similar to handwriting, fingerprints can be directly converted into graphs taking the form of mathematical structures consisting of edges (links) and vertices (nodes). Through this conversion, the minutiae of the fingerprint—the bifurcations, terminations, etc., can be treated as vertices (nodes) while the connecting ridges become edges (links).

In the graph context, a latent print can be treated as a part of the sub-graph structure of the exemplar print even though both are actually captured at different times under different circumstances. The embodiments described herein include a matching routine that maps similar embedded sub-graph structures between latent prints and corresponding exemplars. Such a methodology can be used to address the vital problem of exploiting partial prints found at crime scenes.

There is considerable information in Level 1 and Level 2 features that are untapped by conventional methods. The graph-based techniques herein discussed can capture much of this information.

Furthermore, since fingerprint experts rely on Level 3, i.e., pores within the ridges, features for identification, the Graph-based methods described herein also offer a framework for quantifying Level 3 features by incorporating them in the information associated with the appropriate graph edge that matches the fingerprint ridge where the Level 3 features are located. Level 3 features expand the discriminating power that graphs bring to fingerprints. The embodiments described herein provide two distinct strategies for exploiting the biometric power of fingerprints. The first involves capturing the topology and geometry of the ridges in the form of a graph and the second expands the features associated with the graph to include the fine details available within the ridges.

The inherently graphical structure of fingerprints presents a wealth of topological and geometric information. Graph-based Recognition, as described herein, is particularly well suited for mining the identity-related information embedded in fingerprints. This effort entails extracting mathematical graphs from fingerprint information and drawing upon key properties of these graphs such as topology and geometric features to extract data. Ridges are transformed into edges and minutiae become vertices in graph-based fingerprint representations.

The systems and methods described herein derive power from the ability to discriminate and to match fingerprints using “conditionally embedded” sub-graphs.

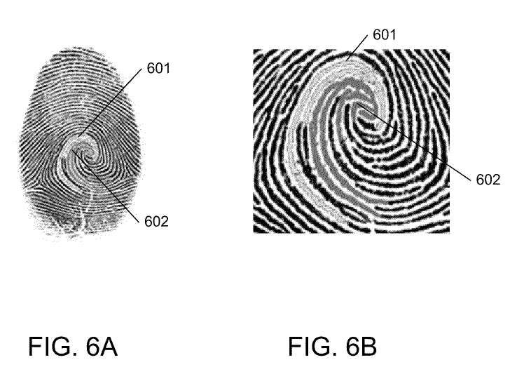

FIG. 6A is an image that shows a fingerprint with two samples of embedded sub-graphs 601 and 602. FIG. 6B is a close up of the sub-graphs 601 and 602. The sub-graphs are the equivalent of the sub-graphs illustrated in FIG. 1 for Chinese words.

Once a fingerprint has been rendered into a graph, fingerprint images can be parsed into sets of conditionally embedded sub-graphs. Conditionally embedded sub-graphs are embedded graphs that can be referenced both as a part of the larger graph and as an individual entity with its own topology and geometric features. The graph-based methods described above and in the related patents and applications permit complex graphs to be viewed from multiple perspectives. One perspective may be the complete form such as the full Chinese word or the full image of a fingerprint. Concurrently, the various graphs embedded in these full forms can also be viewed and treated as if they were physically extricated from the full graph. This ability to view a whole object as a collection of embedded “parts” has been the key to success with handwriting recognition and it offers enormous potential for matching fingerprints.

The fact that these graphs can be referenced as necessary leads to their label: conditionally embedded graphs. The distortions affecting any fingerprint suggest that latent and exemplar images might not contain exactly the same number and type of sub-graphs. This problem is very similar to issues related to recognizing handwritten words. Conditionally embedded sub-graphs enable isolation and identification of the similar elements between two graph-based forms while localizing the differences.

The first step toward applying graph-based analysis to fingerprints entails locating graphs. As shown in FIGS. 6A and B, graphs can be anchored to measurable features within the print such as terminal points or bifurcations. The graphs may transcend minutiae, or they may originate at a minutiae point and extend for a prescribed distance. They key is to establish a graph building process that will generate comparable structures from different images—full or partial—of the same fingerprint. There are two critical decisions that will define graph building from fingerprints: (1) Detection of points for anchoring the graphs and (2) Developing rules for extending the graphs from these anchor points

Regarding the first item (anchor point detection) the current minutiae offer a rich source of features that can be reliably detected. Ridge bifurcations and ridge endings represent two features within fingerprints that can be reliably detected.

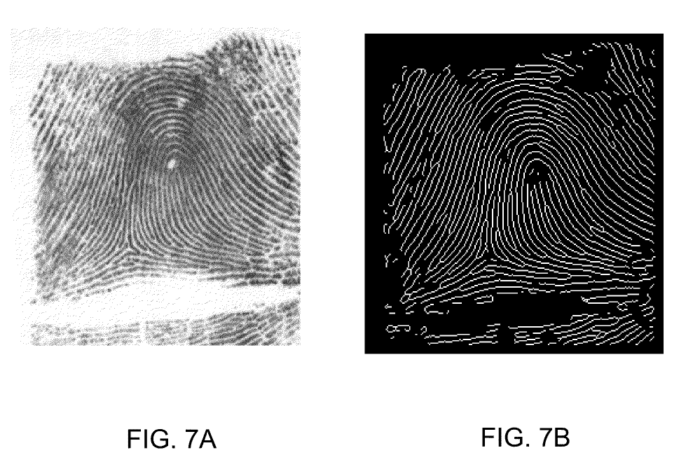

In order to extract the minutiae, the gray-scale image can first be converted into a bi-tonal version, and then the bi-tonal image can be skeletonized. The naïve, conventional method of applying a global threshold to the image will discard a large amount of useful information, and it will also introduce phantom features as a side-effect. Moreover, the conventional skeletonization algorithms create numerous spurs, which further degrade the result. Using advanced image processing techniques such as morphological reconstruction and background illumination correction, it is possible to compensate for the brightness and unevenness caused by pressure variations. And, ridge detection and related algorithms, as described herein, can extract ridges reliably from the brightness-adjusted images, as shown below in FIGS. 7A and B, which illustrate an original fingerprint and ridge lines extracted therefrom.

Variations in ridge thickness caused by moderate amounts of smearing are easily handled by a ridge line extraction process. Conventional mage processing techniques, however, cannot cope with spurious features introduced by skin elasticity. The methods described herein tackle this problem using a robust graph matching algorithm. Such a graph matching algorithm can locate the minutiae and compute various kinds of statistics on them. Surely, spurious minutiae caused by skin elasticity will also be counted by such a matching algorithm. However, it is likely that these spurious features will be drowned out by the large number of true features, thereby allowing such a statistical graph matching algorithm to function properly.

FIG. 8 shows samples of ridge bifurcations 801 and endings 802. Both of these features provide definitive locations for anchoring graphs embedded within a fingerprint image.

Given the establishment of anchor points, two strategies are immediately apparent for “growing” graphs from these points: 1. Extending from the anchor point along ridges for a prescribed distance, and 2. Extending from the anchor point along ridges until another anchor point is encountered.

Implementing a strategy for growing graphs involves addressing possible breaks in ridges that are related to image quality as opposed to true ridge features. FIG. 9 shows samples of definite 901 and possible 902 ridge breaks.

Whether ridge breaks do or do not occur in an image will determine the connectivity of ridge features. FIGS. 10A-C shows how ridges can extend as the image becomes increasingly blurred and the number of breaks in the ridge becomes reduced.

Ridge connectivity is a concern even outside the usage of graphs since too many connections can lead to both missed and false minutiae. Graphs offer a solution for dealing with potential ridge breaks. This solution takes the form of routinely closing the gaps and establishing “soft vertices” at these points. In this context, two types of soft vertices will be generated: 1. Degree 3 soft vertices that connect potential bifurcations; and 2. Degree 2 soft vertices that connect end points at ridge breaks.

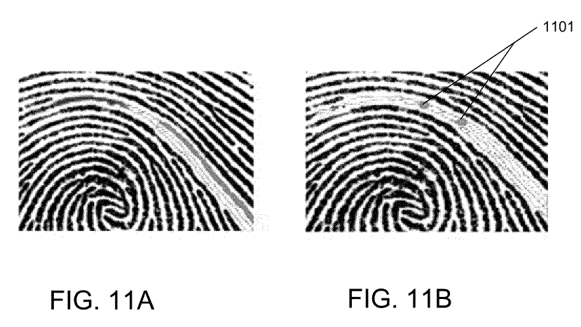

Soft vertices become placeholders for potential breaks in connectivity. As such, they can be used to reduce variability in graph building related to image distortions. FIGS. 11A and 11B show how the insertion of soft vertices 1101 can be used to connect ridges and preserve potential features.

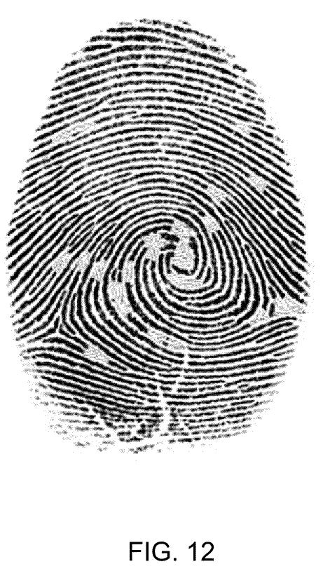

The discussion presented herein is intended to illustrate some general approaches for converting fingerprints to graphs constructing conditionally embedded sub-graphs. FIG. 12 shows the location of a particular graph type with a single central vertex and three edges. These graphs 1202 can be extracted in groups to create larger more complex graphs. Each of the larger composite graphs can be categorized by its topology and geometry.

Graph-based Data Representation (“GDR”) is a method developed for structuring physical data and relational information associated with that data in a compact computable structure. GDR employs principles of Graph Theory to produce a data structure in which individual pieces of data are organized within the framework of mathematical graphs. Thus, the data structure consists of two elements: (1) the underlying graph and (2) the data. Bundling relational information and data within the same “packet” creates a structure highly tailored to certain types of problems. GDR is possible because of an algorithm that assigns a unique code that represents the topology of any graph. That is, if two graphs are structured in the same way—that is, they are isomorphic—the GDR algorithm will always assign them the same code. An added advantage of GDR is when two graphs produce the same code, the “alignment” of their topologies is known and one-to-one comparisons can be made between corresponding data based on this alignment.

In the handwriting problem, written forms are converted into GDR data structures and recorded as reference material. When a new written form is encountered, it too is converted into a GDR structure and very efficiently compared to the known forms. This efficiency is possible because the data records can be referenced using the graph codes as keys. As further evidence of the power of GDR, key codes can be generated for graphs embedded in larger graphs so it is possible to recognize characters and words even if they overlap or connect or are encumbered in a very noisy background. Because of their graph-like structure consisting of ridges and minutiae, fingerprints are amenable to graph-based analysis as well when using the systems and methods described herein. Other applications, such as photographic imagery, require more complex methods for graph generation.

Once fingerprints have been parsed into a meaningful set of graphs, the next step is to convert the graphs into a data structure.

The GDR data structure captures both topological relationships and concomitant feature data. Every graph-base record has three components:
1. The graph topology code which is a numeric descriptor that is the same for all isomorphic topologies. That is, any two graphs with the same number of edges and vertices connected in exactly the same manner will generate the same code—even if their shapes may vary. This code addresses only topology.
2. The graph alignment map which captures the point-to-point correspondence between the graph and all other graphs found to be isomorphic to it. This component enables detailed comparisons among graphs since they can be compared on specific corresponding details.
3. The feature data which in this case will take the form of physical measurements extracted from the fingerprint. Features include physical distances, angles and other descriptors. One example of another descriptor is the Bezier Point feature which describes complex curves as a compact set of points.

Fingerprints can be converted into a database consisting of records containing the above cited components. The information will be accessible through the conditionally embedded sub-graphs.

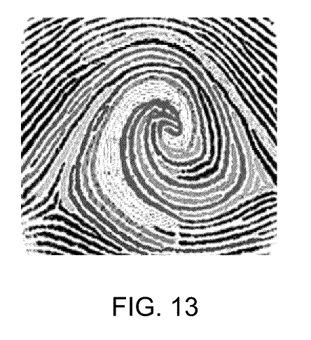

FIG. 13 shows how a fingerprint could be divided into embedded sub-graphs. What distinguishes conditionally embedded sub-graphs from other sub-graphing schemes is that the actual creation of the sub-graphs remains fluid. That is, the conditionally embedded graphs encompass the graphs illustrated in FIG. 13, plus other possible graphs that can be produced within the fingerprint image.

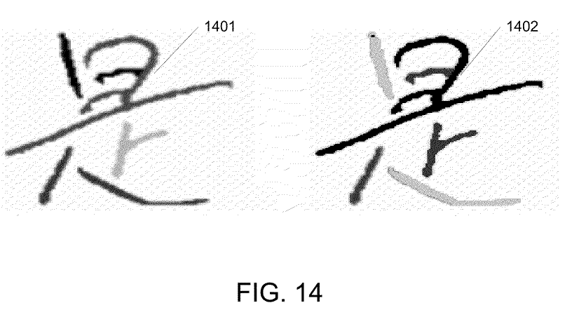

Rather than pre-defined embedded forms, conditionally embedded graphs exist as a table of indices to multiple, often overlapping, embedded forms within a complex graph. FIG. 14 shows two examples 1401 and 1402 of conditionally embedded sub-graphs within the Chinese word shown in FIG. 1.

The examples shown are just two of multiple combinations of embedded sub-graphs that can be conditionally referenced through a graph indexing method. Similar methods can be applied to fingerprints to permit the comparisons of various embedded sub-graphs.

Fingerprint matching using graph-based methods can be accomplished through a two-stage process: Stage 1: Enrollment of the Exemplar Images: and Stage 2: Matching of Latent print images against the Exemplars.

In the first stage, Exemplar images—such as the “short list” that results from AFIS—can be converted into Graph-based Data Representations and stored in a database. Ridge detection would be the means for graph generation with soft vertices inserted into places where edge breaks might potentially occur. The full Exemplar image along with its sub-graph structure would be stored in a database that includes both the topology for the full and sub-graphs and the actual physical measurements extracted from the image.

The index to this database would be through the conditionally embedded sub-graphs. Similarly, latent images would also be converted into Graph-based Data Representations and then compared to the Exemplar records.

Matching occurs at two levels: 1. The first level of matching occurs at the graph isomorphism level. That is, Latent print graphs are compared with Exemplar print graphs having isomorphic topologies. Only graphs possessing the exact same topology will generate the same code. And, 2. For those graphs having identical topologies, detailed feature matching will be performed. It should be noted that feature matching can be performed both at the “coarse” and “fine” detail levels. An example of a coarse feature would be a “shape code” based on directional relationships among graph components such as directions among graph vertices (minutiae). When two graphs possess the same topology codes and shape codes, they will be identical in structure and very similar in appearance. A fine detail feature can include curve comparisons accomplished by comparing Bezier representations of curves.

Matching can take place both for connected sub-graphs as well as multi-graphs consisting of multiple unconnected sub-graphs. The actual method used for matching can actually be one of several methods, including but not limited to Linear Discriminant Analysis, Regression Tree Classification, and others.

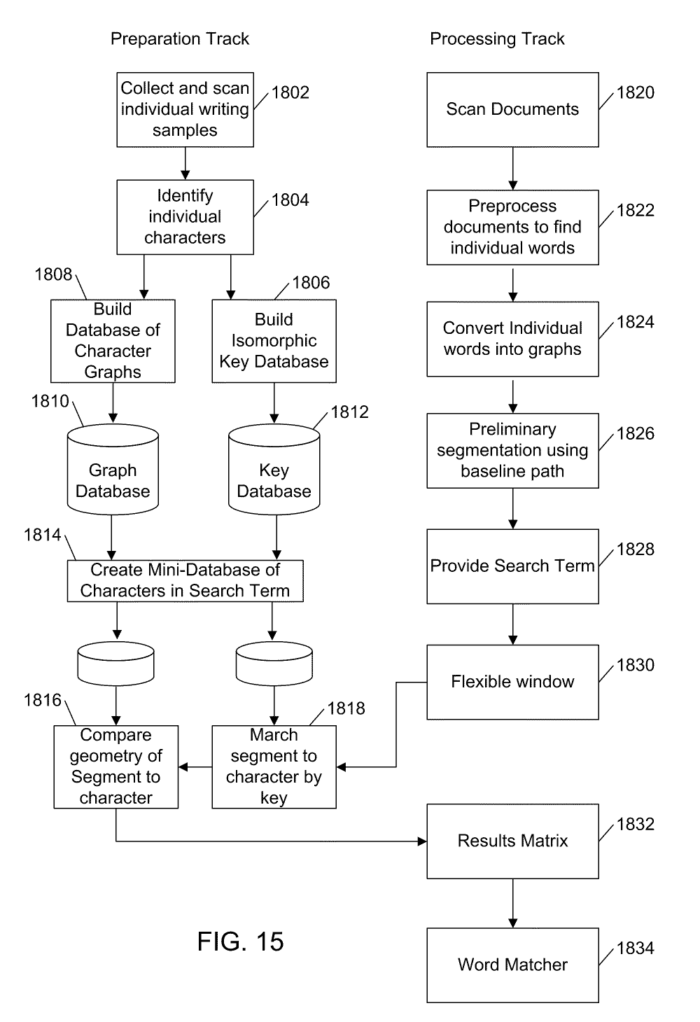

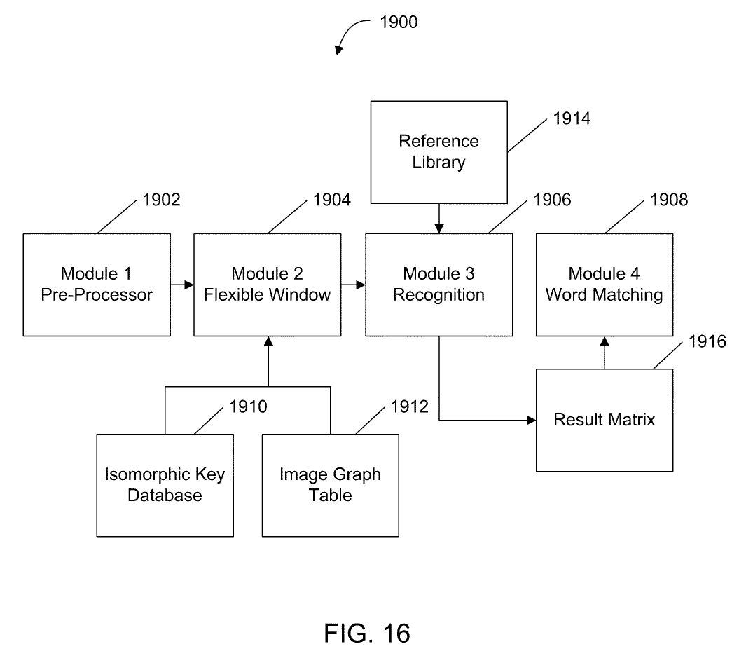

FIGS. 18 and 19 in the '375 application illustrate example systems and methods for locating specified search terms in scanned documents. These figures are recreated and FIGS. 15 and 16 and the accompanying description follows. It will be understood that the system and method of FIGS. 15 and 16 herein can be modified for fingerprints. Some of these modifications are noted below, but others will be apparent from the description herein. As can be seen, the process of FIG. 16 can comprise two sub-processes: preparation and processing. The actual process of image detection, however, includes the following stages and corresponding steps:

Stage 01: Image Reduction (steps 1802 and 1804);

Stage 02: Graph Generation (step 1806);

Stage 03: Isolation (step 1806);

Stage 04: Connectivity Key Generation (step 1808);

Stage 05: Connectivity Key Matching (step 1808);

Stage 06: Feature Comparison (step 1816);

Stage 07: Results Matrix Generation (step I832); and

Stage 08: Word, or in this case print, Matching (step 1834).

The 8 stages identified can, for example, be performed by 4 functional modules as illustrated by the example pictographic recognition system 1900 of FIG. 19. System 1900 comprises the following modules: Module 1: Pre-processor 1902; Module 2: Flexible Window 1904; Module 3: Recognition 1906; and Module 4: Word Matching 1908 and Dynamic Programming. These modules can be included in a computer system. For examples, these modules can be included in code configured to run on a processor or microprocessor based system.

Module 1: Pre-processor 1902 can be configured to perform stage 01: Image Reduction and stage 02: Graph Generation, while Module 2: the Flexible Window 1904 can be configured to perform stage 03: Preliminary Segmentation which can include, preliminary segmentation as described below, stage 04: Connectivity Key Generation, stage 05: Connectivity Key Matching, and stage 06: Feature Comparison. Module 3: Recognition 1906 can be configured to perform stage 07: Results Matrix Generation and Module 4: Word Matching 1908 can be configured to perform stage 08: Word, or print Matching, which can comprise search term tuple matching as described below.

It should be noted that the modules 1-4 depicted in FIG. 16 can comprise the hardware and/or software systems and processes required to implement the tasks described herein. Thus, different implementations can implement modules 1-4 in unique manners as dictated by the needs of the particular implementation.

It should be noted that Module 2 and 3 can be configured to work hand in hand throughout the recognition process by constantly cycling through stages 04, 05, and 06. In this way, segmentation and classification become a unified cohesive process. As image graphs are isolated, they are compared to the image graphs relevant to the search term. If an isomorphic match is found, the matched unknown image graphs must bear some resemblance to reference characters in the search term and are suitable for classification. The classification process assigns a confidence value to this resemblance.

Pre-processor 1902 can be configured to translate binary images into graph forms. In this context, a graph is a mathematical structure consisting of line segments (edges) and their intersections (vertices). The actual graph forms generated by Pre-processor 1902 can be viewed as single line representations of their original images. The graphs, as stored in computer memory, contain all information required to regenerate these single line representations.

An Image Graph Constructor configured in accordance with the systems and methods described herein can be configured to convert binary images into graphs through 2 steps: Image Reduction and Graph Generation. Image Reduction can consist of identifying points in the original image, that correspond to vertices in the related graph, which is a single line re-creation of the image. Once the vertices have been established, the edges become those portions of the image that connect between vertices.

There are alternative techniques for accomplishing the Image Reduction. As described above, one approach is to use a skeletonization technique to “thin” the image into a single line form, and then to identify vertices based upon prescribed pixel patterns. The skeletonizaton method is well documented through numerous alternative approaches. Another technique would be to identify “nodal zones” as the intersection of major pathways through the image. This can be done by calculating the tangents of the contours of an image and comparing the length of these tangent lines to an average stroke width for the entire image. The tangents become quite long near nodal areas. In either case, the desired output should remain consistently as follows: a) A list of connected components; b) For each line: Pointers to the corresponding nodes, pointers to the line's contours, pointers to the contour end points, and the estimated direction of the line at each end; c) For each node: An ordered list of node-line connections. The order in the list corresponds to the attachment of the line ends to the node when traveling clockwise around the node; and d) For each node-line connection: A pointer to the line, and the identification of which end connects to the node. In addition, a pointer to the portion of the node's contour that follows the connection clockwise.

Upon receiving the above data, Pre-processor 1902 can be configured to commence the Graph Generation. This stage can entail creating a single-line structure comprised of edges and vertices. This stage can be used to establish the proper edges, and designate their intersections as vertices. Skeleton data can be used directly. If contour data is provided, the contours are first converted into single-line data representing the “mid-line” of parallel contours. Once the contours have been converted to edges and the nodes to vertices, the end points for each edge are associated with the proper vertices. At this point the “rough” form of the graph has been created.

The next step entails graph refinement. First, the Degree 2 vertices are created. There are two types of Degree 2 vertices: a) Corners, and b) Zero Crossings. Corners represent points at which relatively straight line segments change direction. Zero crossings are points at the juxtaposition of opposing curves. The peak at the top of an upper case “A” is a good example of a corner and the center point of the character “s” illustrates the concept of a zero crossing.

Once the Degree 2 vertices have been added, further refinements are preformed. These include: a) Removal of insignificant features; b) Closure of gaps; and c) Merger of features in close proximity. Integral to the image graph is the actual method by which it is stored. Rather than drawing upon the common practice of storing information in the form of data elements, graph information can be stored as a series of relationships. That is, rather than storing information as a linear data record, graph information is stored as a series of memory locations with each location containing both data an “pointers” to other locations. Pointers are variables, which contain addresses of memory locations; each pointer exactly replicates the vector nature of the vertices and edges of the graphs they represent.

Equating this concept to the edge/vertex structure of a graph, each memory location represents a vertex and each pointer to another location represents an edge. The concept as described so far provides a good descriptor of the structural relationships that comprise a graph; however, they do not address the issue of features, which is critical to the visual representation of both graphs and characters. Aside from the pointers stored at the vertex memory locations additional data is also stored to describe the features of the various edges, that intersect at a particular vertex. These data include all salient information captured during the Image Reduction process including directional information, distance measurements, curvature descriptors and the like.

A moving window that travels across a word 1904 can be configured to analyze processed word graphs using a Flexible Window concept. This concept represents an application of Graph Theory. In operation the Flexible Window isolates connected sections within a cursive word form that conform to items in the Reference Library of character forms. The Flexible Window 1904 effectively uses a “Virtual Window” of variable size corresponding to the grouping of edges and vertices extracted at any given time. Thus, it performs both segmentation and recognition in a single step. Fundamental to the operations of the Flexible Window 1904 is the use of isomorphic graph keys, which are the actual tools, used to identify portions of a cursive word, which match items in the Reference Library. Isomorphic graph keys are rooted in the premise that any two graphs which are structurally identical, e.g., the same number of edges and the vertices connected in the same manner, can be described by the same unique key. The key under discussion is actually derived for the adjacency matrix for the graphs and thus, the concept of key matching is equivalent to comparing the adjacency matrices for two graphs. If the adjacency matrices of two graphs match, they are isomorphic or structurally identical. The process of Connectivity Key generation is a straightforward process herein described. The best way to illustrate the function of the Flexible Window 1904 is to describe its activities on a step-by-step basis.

First, the Flexible Window 1904 can be configured to use the concept of the Baseline Path. For illustrative purposes, FIG. 20 of the '375 application shows examples of how a Baseline Path can be generated according to one embodiment of the systems and methods described herein. Item a in FIG. 20 shows a sample word image. Processing is done to “skeletonize” the image into a graph object with vertices (nodes) and edges (FIG. 20, Item b). In this example, the regular dots represent points on an edge and the box dots represent vertices.

The process for creating the baseline path starts by identifying the left-most and rightmost lowest edges (shaded darker) in the graph object model (FIG. 20, Item c). In the illustrative example, this would be the “C” and the trailing edge of the letter “r” respectively.

The next step involves constructing a series of connected edges from this graph object model that starts at the left-most lowest edge and ends at the right-most lowest edge. This, in essence, creates a “path” through the graph of an imaged word. Since handwriting is usually connected on the bottom of a word, this process will create a “baseline” path (FIG. 20, Item d).

For disconnected handwriting, all of the above processes are repeated on each individual connected sub-graphs. For example take the word “Charles” (FIG. 21, Item a). This word becomes the graph with baseline path shown in light gray (FIG. 21, Item b). As shown in the illustration, the above process outlined is repeated on the two sub-graphs.

With the construction of the baseline path, it is now possible to segment automatically cursive words or streams of connected characters into individual letters. For illustrative purposes, the word “Center”, in FIG. 20, can be used as an example. FIG. 20, Item d shows the word Center processed into a set of connected edges along the base of the word.

The segmentation routine works on all edges except for the last one and is accomplished by “walking” along the baseline path. Since, trailing edges are usually connected to a letter they should not be processed. Also, the walking direction of an edge is determined by the general direction of walking from the starting edge to the trailing edge. To illustrate, directional arrows are shown on the Center example in FIG. 20, Item e.

“Walking” along an edge, follows a path that consists of states from using 3 consecutive pixels. The 3 pixels give rise to 5 states (flat, increasing, decreasing, minimum, and maximum). These are illustrated in FIG. 22, Item a. These states are assuming a walking direction from left to right except where ambiguous; the ambiguity is resolved by indicating a direction with an arrow.

The following rules apply to the segmentation process: Rule #1—Before beginning segmenting, find a decreasing state before any segmentation is allowed. Once this state has been noted, a “break” will be made at the first increasing point after this decreasing state has been detected. Subsequent breaks along the same edge must follow this pattern as well. For very short edges, minimums are also considered for breaking points. This is the first set of heuristics, which the segmentation algorithm follows; Rule #2—The second set of rules involves analysis of an edge being a “connector”. A connector is defined to be an edge that separates the graph into 2 distinct pieces, i.e., the sub-graph to the left of the starting vertex and the sub-graph to the right of the ending vertex of an edge share nothing in common. The sub-graph to the left must contain the starting edge. And the sub-graph to the right must contain the ending (trailing) edge. All edges that may have breakpoints must follow this rule; and Rule #3—When an edge follows the above two rules, breakpoints are computed. If no breakpoints can be found, then the last rule is used. If the states were mostly increasing, it was most likely to be an ascending connector. One break is made on the midpoint of an edge like this.

The first two rules can be shown through the following example. FIG. 22, Item b shows the skeleton of the cursive lowercase ‘s’ with baseline edges in light gray and breakpoints in box dots. The first two rules must be followed for there to be a break. Therefore, the breaks would occur at the box dots.

FIG. 22, Item c, provides an example of the second and last rule using lowercase T. On the edge with the second breakpoint, rules #i and #2 were never encountered. But rule #2 and #3 were encountered and a breakpoint was made in the “middle” of the edge. It should be noted that the strictly descending edge in the middle of the ‘j’ does not follow rule #1 or #3.

In the selected example, the word “Center” has breakpoints (FIG. 20, Item f.) at the following locations indicated with arrows. Once these breakpoints are found, the process of creating letters can' begin. Each breakpoint gives rise to 2 edges. Each distinct grouping of edges between breakpoints forms a subgraph that we dub a letter. FIG. 20, Item g, shows the output of the word center using this definition. The technique illustrated is intended for cursive script English and other “naturally” cursive languages such as Arabic. This technique is usually not necessary for hand or machine printed words, since printed characters are typically segmented by the nature of writing.

When handwriting an “i” or a “j”, diacritics are typically used such as a dot floating above them. For purposes of segmentation, this case is handled by treating the dot as a subgraph and spatially putting it as close between two letters as possible.

The Flexible Window 1904 can be configured to move in an “inchworm” fashion from one segmented zone to another. Typically this process moves from left to right, but this order is not mandatory. For languages such as Arabic, the Flexible Window would move from right to left following the natural written order of the language. Thus, the process creates a “Virtual Window” of variable size, which encompasses all items in a segmented zone at a given time. This is illustrated in FIG. 23. It should be noted, however, that rather than using a fixed size the variable window is a product of the size and position of extracted edges that is contains. As previously discussed, a table 1912 of all possible graph forms is available to support the recognition process. Table 1912 can be created on a one-time basis only and serves as an ongoing resource to the recognition process. For instance, if the isomorphic database is configured to include all graphs up to order 11 (11 vertices), the total number of vertices in the segmented zones should not exceed eleven.

Using the Connectivity Key generated from an Order 8 or less graph extracted from unknown image graphs, the Flexible Window 1904 can be configured to locate the matching record in isomorphic key database 1910. Since all possible graph forms are in the database, a record will always be found through this lookup process. This record contains a series of masks, which serve as the bridge between all sub graphs within the unknown graph and items in the Reference Library. The size of the mask will correspond to the size of the graph being processed. For instance, a graph with eight edges, will have ail 8-bit mask and a graph with twelve edges will have a 12-bit mask. Thus, considering a graph with eight edges as an example, the actual process for matching against Reference Library graphs is driven by information extracted from the database in the form of a string of 8-bit masks in which the bits set to “1” designate the edges in the graph which should be considered.

Through the use of masks a series of sub-graphs can be generated from within the Order 8 or less graph extracted from the unknown image. The Flexible Window 1904 guarantees that each item in this series is structurally identical to at least 1 item in the Reference Library.

At this point, matching has been made only in terms of structure with no consideration given to features. Thus, while the Flexible Window 1904 guarantees a topological match, most of the graphs isolated by Flexible Window 1904 are not necessarily valid characters. However, the probability is very high that the correct characters are within the set of graphs isolated by the Flexible Window 1904. Such a determination, however, can only be made while giving consideration to geometry. Thus, this is the point at which the Flexible Window 1904 passes information to the Recognizer 1906.

The Recognizer 1906 can be configured to make the actual determination whether a graph isolated by Flexible Window 1904 conforms to an item in the Reference Collection. This determination is made on the basis of feature comparisons.

Following is a listing of sample features used for this purpose, each with an attendant narrative description: Absolute Distance, which can be the physical distance among graph edges and vertices; Centroid Direction, which can be the direction from graph edges and vertices to the center of mass of the graph; Centroid Distance, which can be the physical distance from individual graph edges and vertices to the center of mass of the graph; Edge Area Moments, which can be the second moment of individual graph edges; Edge Aspect Ratio, which can be the ratio of height to width for individual edges; Exit Direction, which can be the direction an edge exits a vertex; Expected Distance, which can be the position of an edge or vertex in one graph based on the position of a corresponding edge or vertex in another graph; and Graph Direction, which can be the direction from one graph component (edges and vertices) to another. The above mentioned features are provided for illustrative purposes only and do not represent a comprehensive listing of all features that can be used to compare isomorphic graphs to determine whether they represent the same character.

Since the graphs extracted from the unknown image and their corresponding graphs from Reference Library 1914 are guaranteed by Isomorphic Database 1910 to be structurally isomorphic, by definition they must have the same number of edges and vertices connected in the same manner. In addition to guaranteeing this correspondence, Isomorphic Database 1910 also guarantees alignment. That is, the features from graphs extracted from an unknown image are mapped to the corresponding features of the known reference graphs. This—is a one-to-one correspondence, which establishes which features must match for a valid comparison to occur. The align is achieved by rearranging the vertices as per the translation code from isomorphic database 1910. The concept of alignment was previously discussed in terms of vertex translation and the “Translation Table”. Thus, since the alignment is known, the task of Recognizer 1906 is to assign a level of confidence to the comparison between the known and unknown graph forms. The basis for determining this confidence is rooted in distance measurement. In practice, it has been found that unknown characters which receive the lowest distances scores usually resemble the known character to which they have been matched. As the distances rise, the topological structure still holds but the visual similarity disappears.

As Recognizer 1906 classifies characters, it can be configured to record the results with scores above a prescribed threshold. The Recognizer 1906 also can have a feedback mechanism, which eliminates from consideration simple embedded forms, which are likely to occur in more complex forms. For instance, a single stroke character such as “1” occurs in almost every complex character. Thus, if a complex character is identified, it is not necessary to evaluate every simple form, which may be embedded inside it.

Once the Recognizer 1906 has completed its work, it places its results in Results Matrix 1916. The Results Matrix 1916 can be a tool for identifying characters embedded within a cursive word with their actual physical locations. The Result Matrix 1916 can contain the following information: a) Character name, e.g., from Reference Library 1914; b) Physical coordinates in image (x1, y1)-(x2, y2); and c) Distance Score: how far the features from the unknown word matched the features of the known characters.

The contents of the Results Matrix 1916 are passed directly to the Word Matcher 1908, which can be attempts to match the search term with characters in Results Matrix 1916.

Underlying the Word Matcher 1909 is the concept of tuples: 3 letter combinations of letters, which are sequential but not necessarily contiguous. A word is matched by mapping tuples generated from individual words in the unknown image against the prescribed search term. Once the scores have been established, they can be ranked with the highest one selected as the most likely choice. To facilitate the matching process, a full set of tuples is generated for the search term. This listing is used to map the tuples from the unknown word against the search term in a very efficient manner. When placed within the recognition environment, system 1900 will continually be confronted with new listings of words or names. Thus, system 1900 can continually regenerate master sets ortuples. Also underlying the Word Matcher is the concept of Dynamic Programming which compares two character patterns and determines the largest pattern common to both.

The Word Matcher 1908 allows for some fuzziness when mapping tuple against words. Fuzziness relates to the position in which a character occurs. An exact tuple match would mean that every character extracted from the Results Matrix matched the exact character positions in the search term. The introduction of fuzziness means that the character location can be “plus or minus” a certain prescribed distance from the actual position of the search term characters they match. This “prescribed value” can be a variable, that can be adjusted. However, if a tuple maps against a word with variation greater than the prescribed fuzziness, it should not be scored as a valid match. The quantity of tuples from the matrix matched against the search term determines whether a document should be flagged for further investigation. Dynamic Programming is a well documented method for comparing patterns in character strings. For present purposes, the contents of the Results Matrix can be considered to be one string and the search term can be considered to be the other string. In the case of the present invention, however, the Results Matrix offers alternative choices for particular character string positions. This represents an extension over traditional Dynamic Programming approaches.

It will be understood that word matcher 1908 can be a print matcher in the embodiments described herein.

While certain embodiments have been described above, it will be understood that the embodiments described are by way of example only. Accordingly, the systems and methods described herein should not be limited based on the described embodiments. Rather, the systems and methods described herein should only be limited in light of the claims that follow when taken in conjunction with the above description and accompanying drawings.

What is claimed is:

1. A method for fingerprint recognition, comprising:
converting fingerprint specimens into electronic images;
converting the electronic images into mathematical graphs that include a vertex and an edge;
detecting similarities between a plurality of graphs;
aligning vertices and edges of similar graphs; and
comparing similar graphs.

2. The method of claim 1, wherein converting the handwriting specimens into electronic images comprises, converting the handwriting samples into bi-tonal electronic images.

3. The method of claim 1, wherein converting an electronic image into mathematical graphs comprises converting the electronic image into an image skeleton.

4. The method of claim 3, wherein converting an electronic image into a mathematical graph further comprises transforming the image skeleton into one or more edges and one or more vertices.

5. A fingerprint recognition system for searching fingerprints in a source language comprising:
an imaged fingerprint, the imaged fingerprint being stored in a fingerprint database;
a fingerprint library for storing fingerprint templates;
an image graph constructor coupled to the fingerprint database and the template library, the image graph constructor configured to generate image graphs from the templates, and generate a collection of image graphs representing the imaged fingerprint by performing an image graph generation process, the process comprising the steps of:
reducing fingerprint features in the templates and in the imaged fingerprint to skeleton images comprising a plurality of nodes and a plurality of connections,
representing the skeleton images using a Connectivity Key that is unique for a given plurality of nodes and connections between the given plurality of nodes, and
constructing the template graphs and collection of image graphs from image graphs of the imaged fingerprint;
an image graph database for storing the template image graphs and the collection of image graphs generated by the image graph constructor; and
a comparison module coupled to the image graph database, the comparison module configured to search the imaged documents by comparing the collection of image graphs with selected template image graphs, wherein if at least one image graph from the collection of image graphs matches the selected template image graphs, the imaged fingerprint is flagged.
